(19) United States
(12) Patent Application Publication
(10) Pub. No.: US 2008/0281753 A1
(43) Pub. Date: Nov. 13, 2008

(54) HANDLING OF ACH PAYMENT REJECTIONS SYSTEMS AND METHODS

(75) Inventors: Michael L. Sgaraglio, Massapequa Park, NY (US); John Collins, Bethpage, NY (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Greenwood Village, CO (US)

(21) Appl. No.: 11/747,576

(22) Filed: May 11, 2007

(51) Int. Cl. G06Q 20/00

(52) U.S. Cl. 705/39

(57) ABSTRACT

Methods, systems, and machine-readable media are disclosed for processing financial transactions. According to one embodiment, a method for processing financial transactions prior to a collection of payment for the transactions can comprise receiving information related to a plurality of transactions from a party to the transactions. One or more rules can be applied to the information related to the plurality of transactions. The one or more rules can define dispositions of the payment for the transactions to provide for collection of fees associated with the transactions. Payment for the transactions can be handled based on applying the one or more rules.

### BACKGROUND OF THE INVENTION

Embodiments of the present invention relate generally to financial transactions. More specifically, embodiments of the present invention relate to methods and systems for reducing risk associated with handling rejected payments.

Various types of financial transactions, including for example consumer purchases or payments made using credit cards, debit cards, checks, or other instruments other than cash, typically involve a number of different entities. For example, the primary parties to the transaction include the consumer and the merchant or other supplier of the goods or services being purchased or paid for. Also included is the financial institution issuing the instrument being used, often referred to as the issuing financial institution. An acquirer can act as an intermediary between the issuing financial institution and the merchant.

For example, a typical credit card transaction in which a consumer makes a purchase from a merchant using a credit card involves the following steps. First, the merchant calculates the amount of the transaction or purchase and seeks payment from the cardholder. The cardholder then presents the merchant with his/her credit card. The merchant then runs the credit card through a point of sale terminal. The point of sale terminal captures credit card and sales information and sends such information together with an authorization request to the acquirer. The acquirer, in turn, processes the information received from the point of sale terminal and forwards any relevant information and the authorization request to the issuing financial institution. The issuing financial institution processes the relevant information and the authorization request to determine whether the transaction should be authorized. The issuing financial institution then sends an approval or denial code back to the acquirer. The acquirer relays the approval or denial code to the point of sale terminal for use by the merchant. If the transaction is authorized, the cardholder is allowed to consummate the transaction with the merchant. Typically, at a later time, the accounts maintained by the issuer and the acquirer are settled and reconciled. The end result is that the issuer transfers the transaction amount minus a fee to the acquirer. The acquirer then deducts a fee from the amount received from the issuer. Additionally, the acquirer may deduct a chargeback amount for any rejected payments. The remaining amount is then transferred by the acquirer to the merchant's account. The issuer also bills the cardholder for the transaction amount by sending the cardholder a credit card statement. The cardholder is typically billed by the issuer on a monthly cycle.

A problem can arise however for the acquirer if the fees or chargebacks owed by a merchant exceeded the amount received from the issuer. In such a case, the acquirer could not, at that time, recover the total amount of fees and/or chargebacks. Previously, an acquirer would try to reduce this risk by holding funding for the merchant for some amount of time. However, merchants are generally not pleased by delays in receiving the funding. Hence, there is a need for improved methods and systems for handling payments to a party to a financial transaction while reducing the risk of not being able to collect fees and chargebacks incurred by that party.

### BRIEF SUMMARY OF THE INVENTION

Methods, systems, and machine-readable media are disclosed for processing financial transactions. According to one embodiment, a method for processing financial transactions, including but not limited to automated clearinghouse (ACH) transactions, prior to a collection of payment for the transactions can comprise receiving information related to a plurality of transactions from a party to the transactions such as, for example, a merchant. One or more rules can be applied to the information related to the plurality of transactions. The one or more rules can define dispositions of the payment for the transactions to provide for collection of fees and/or chargebacks associated with the transactions. Payment for the transactions can be handled based on applying the one or more rules.

Handling payment for the transactions based on applying the one or more rules can comprise initiating a collections process or updating a previously initiated collections process. In other instances, handling payment for the transactions based on applying the one or more rules can comprise initiating a pre-collections process. The pre-collections process can comprise, for example, requesting payment from the party to the transactions and/or debiting an account of the party to the transaction the amount of the fees. In other cases, handling the payment for the transactions based on applying the one or more rules can comprise performing a reserve process. The reserve process can comprise debiting a reserve account maintained for the party to the transaction the amount of the fees. In some cases, the reserve process can further comprises determining whether a balance of the reserve account falls below a minimum amount designated for the reserve account and, in response to determining the balance of the reserve account falls below the minimum amount designated for the reserve account, recovering an amount to replenish the reserve account and crediting the reserve account for the amount recovered. In yet other cases, handling the payment for the transactions based on applying the one or more rules can comprise deducting the fees associated with the transaction from the payment for the transactions.

According to another embodiment, a system for processing an unfunded financial transaction can include a repository having stored therein a plurality of rule sets, wherein at least one rule set of the plurality of rule sets is associated with a party to the financial transaction. The system can also include a processor communicatively coupled with the repository and a memory communicatively coupled with and readable by the processor. The memory can have stored therein a series of instructions which, when executed by the processor, cause the processor to receive information related to a plurality of transactions, including but not limited to automated clearinghouse (ACH) transactions, from a party to the transactions such as, for example, a merchant. One or more rules can be applied to the information related to the plurality of transactions. The one or more rules can define dispositions of the payment for the transactions to provide for collection of fees and/or chargebacks associated with the transactions. Payment for the transactions can be handled based on applying the one or more rules.

Handling payment for the transactions based on applying the one or more rules can comprise initiating a collections process or updating a previously initiated collections process. In other instances, handling payment for the transactions based on applying the one or more rules can comprise initiating a pre-collections process. The pre-collections process can comprise, for example, requesting payment from the party to the transactions and/or debiting an account of the party to the transaction the amount of the fees. In other cases, handling the payment for the transactions based on applying the one or more rules can comprise performing a reserve process. The reserve process can comprise debiting a reserve account maintained for the party to the transaction the amount of the fees. In some cases, the reserve process can further comprises determining whether a balance of the reserve account falls below a minimum amount designated for the reserve account and, in response to determining the balance of the reserve account falls below the minimum amount designated for the reserve account, recovering an amount to replenish the reserve account and crediting the reserve account for the amount recovered. In yet other cases, handling the payment for the transactions based on applying the one or more rules can comprise deducting the fees associated with the transaction from the payment for the transactions.

According to yet another embodiment, a machine-readable medium can have stored thereon a series of instructions which, when executed by a processor, cause the processor to process financial transactions, including but not limited to automated clearinghouse (ACH) transactions, prior to a collection of payment for the transactions by receiving information related to a plurality of transactions from a party to the transactions, such as, for example, a merchant. One or more rules can be applied to the information related to the plurality of transactions. The one or more rules can define dispositions of the payment for the transactions to provide for collection of fees and/or chargebacks associated with the transactions. Payment for the transactions can be handled based on applying the one or more rules.

Handling payment for the transactions based on applying the one or more rules can comprise initiating a collections process or updating a previously initiated collections process. In other instances, handling payment for the transactions based on applying the one or more rules can comprise initiating a pre-collections process. The pre-collections process can comprise, for example, requesting payment from the party to the transactions and/or debiting an account of the party to the transaction the amount of the fees. In other cases, handling the payment for the transactions based on applying the one or more rules can comprise performing a reserve process. The reserve process can comprise debiting a reserve account maintained for the party to the transaction the amount of the fees. In some cases, the reserve process can further comprises determining whether a balance of the reserve account falls below a minimum amount designated for the reserve account and, in response to determining the balance of the reserve account falls below the minimum amount designated for the reserve account, recovering an amount to replenish the reserve account and crediting the reserve account for the amount recovered. In yet other cases, handling the payment for the transactions based on applying the one or more rules can comprise deducting the fees associated with the transaction from the payment for the transactions.

### BRIEF DESCRIPTION OF THE DRAWINGS

FIG. 1 is a block diagram illustrating an exemplary environment in which embodiments of the present invention may be implemented.

FIG. 2 is a block diagram illustrating an exemplary computer system upon which embodiments of the present invention may be implemented.

FIG. 3 is a block diagram illustrating functional components of a system for processing financial transactions according to one embodiment of the present invention.

FIG. 4 is a flowchart illustrating a process for processing financial transactions according to one embodiment of the present invention.

FIG. 5 is a flowchart illustrating an exemplary process of applying a set of rules to information related to a financial transactions according to one embodiment of the present invention.

### DETAILED DESCRIPTION OF THE INVENTION

In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form.

Embodiments of the invention provide methods and systems for processing financial transactions including but not limited to automated clearinghouse (ACH) transactions. In some such embodiments, the processes are executed by an entity, for example an acquirer, on behalf of one or more client organizations. The description below sometimes provides illustrations that use an example where a client organization is a financial institution, but there is no such requirement for the invention and the methods are intended also to be applicable to other types of organizations that make use of large collections of data.

The description herein sometimes refers to “clients” and to “customers.” Reference to “clients” is intended to refer to persons, i.e. individuals, entities, or their agents, on whose behalf a set of information is managed and/or transactions are conducted. Reference to “customers” or “consumer” is intended to refer to persons, i.e. individuals, entities, or their agents, who are the subject of or related to that information. Thus, merely for purposes of illustration, in the case where the information comprises credit-card account records for a credit card issued to Mr. Jones by Bank A, Bank A corresponds to a client and Mr. Jones corresponds to a customer or consumer.

In describing embodiments of the invention, reference is sometimes made to other terms having specific intended meanings. For example, as used herein, the term “payment network” refers herein to an infrastructure that supports that exchange of data in implementing payment transactions. It is anticipated that the data exchange typically proceeds between merchants and financial institutions. Examples of existing commercial networks that are included within the definition of “payment network” include the STAR/MAC network, the NYCE® network, the VISA® network, and the MasterCard® network. Access to a network by a consumer can be achieved through entry of a secret code, such as a personal identification number (“PIN”), in combination with data extracted from the magnetic stripe of a card. In some embodiments, a signature of the consumer may be used in lieu of a secret code. In some instances, particularly in support of transactions having a low value, a consumer might be permitted access to the payment network with only information extracted from the mobile device, without the need to provide a PIN or signature.

The term “payment vehicle” is used herein to refer to a method of payment. For example, payment vehicles can include, but are not limited to credit, debit, stored-value, checks and other types of accounts. In some embodiments, a payment vehicle can include loyalty points or other value accumulated, for example, under a loyalty program.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It being understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination corresponds to a return of the function to the calling function or the main function.

The term “machine-readable medium” includes, but is not limited to portable or fixed storage devices, optical storage devices, wireless channels and various other mediums capable of storing, containing or carrying instruction(s) and/or data. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

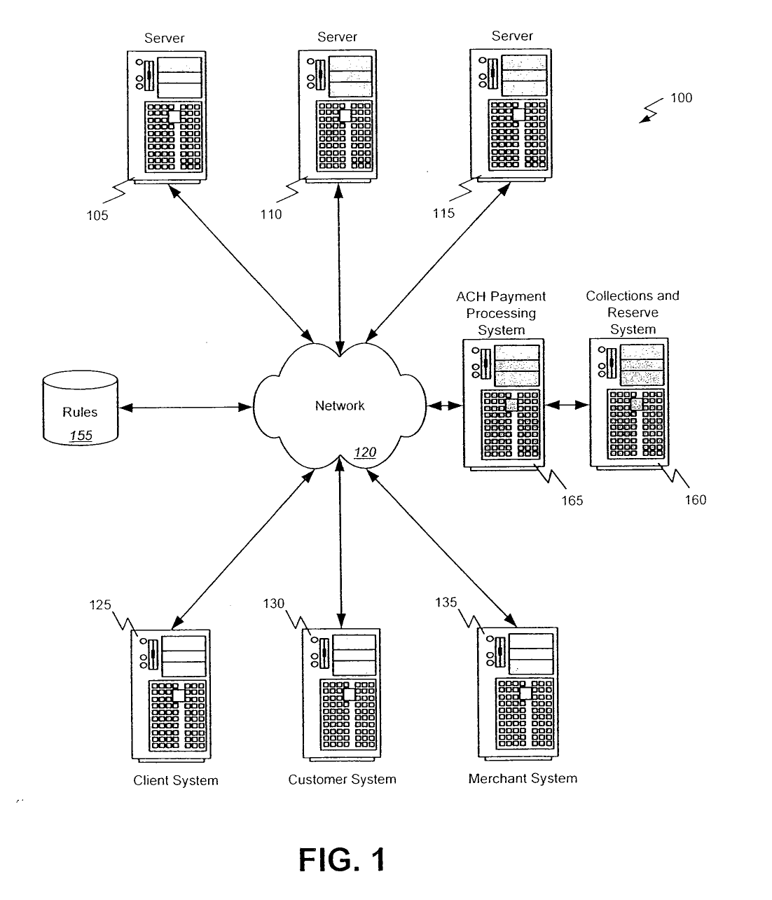

FIG. 1 is a block diagram illustrating an exemplary environment in which embodiments of the present invention may be implemented. In this example, the system can include one or more server computers 105, 110, 115 which can be general purpose computers and/or specialized server computers (including, merely by way of example, PC servers, UNIX servers, mid-range servers, mainframe computers rack-mounted servers, etc.). One or more of the servers (e.g., 130) may be dedicated to running applications, such as a business application, a web server, application server, etc. Such servers may be used to execute a plurality of processes related to financial transactions of one or more consumers on behalf of one or more client financial institutions. For example, one or more of the servers 105, 110, 115 may execute one or more processes for recording transactions on a credit card issued to the consumer by the financial institution. Other processes may provide for paying a merchant for the consumer's purchase, billing the consumer, etc The applications can also include any number of applications for controlling access to resources of the servers 105, 110, 115.

In some embodiments, the system 100 may also include a network 115. The network may can be any type of network familiar to those skilled in the art that can support data communications using any of a variety of commercially-available protocols, including without limitation TCP/IP, SNA, IPX, AppleTalk, and the like. Merely by way of example, the network 115 maybe a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 802.11 suite of protocols, the Bluetooth protocol known in the art, and/or any other wireless protocol); and/or any combination of these and/or other networks such as GSM, GPRS, EDGE, UMTS, 3G, 2.5 G, CDMA, CDMA2000, WCDMA, EVDO etc.

The system 100 can include one or more user computers which may be used to operate a client, whether a dedicate application, web browser, etc. For example, the user computers can include a client system 125 operated by a client financial institution, a customer system 130 operated by a customer or consumer, a merchant system 135 operated by a merchant or vendor, etc. The user computers 125, 130, 135 can be general purpose personal computers (including, merely by way of example, personal computers and/or laptop computers running various versions of Microsoft Corp.'s Windows and/or Apple Corp.'s Macintosh operating systems) and/or workstation computers running any of a variety of commercially-available UNIX or UNIX-like operating systems (including without limitation, the variety of GNU/Linux operating systems). These user computers 125, 130, 135 may also have any of a variety of applications, including one or more development systems, database client and/or server applications, and web browser applications. Alternatively, the user computers 125, 130, 135 may be any other electronic device, such as a thin-client computer, Internet-enabled mobile telephone, and/or personal digital assistant, capable of communicating via a network (e.g., the network 115 described below) and/or displaying and navigating web pages or other types of electronic documents. Although the exemplary system 100 is shown with three user computers, any number of user computers may be supported.

The system 100 may also include one or more databases or repositories 145-155 of data such as a set of rules 155, tables 150 and portfolios for one or more entities 145. The database(s) 145-155 may reside in a variety of locations. By way of example, a databases 145-155 may reside on a storage medium local to (and/or resident in) one or more of the computers 105, 110, 115, 125, 130. Alternatively, it may be remote from any or all of the computers 105, 110, 115, 125, 130, and/or in communication (e.g., via the network 120) with one or more of these. In a particular set of embodiments, the databases 145-155 may reside in a storage-area network (“SAN”) familiar to those skilled in the art. Similarly, any necessary files for performing the functions attributed to the computers 105, 110, 115, 125, 130 may be stored locally on the respective computer and/or remotely, as appropriate. In one set of embodiments, the databases 145-155 may be a relational database that is adapted to store, update, and retrieve data in response to SQL-formatted commands. The databases 145-155 can include a wide variety of information related to financial transactions related to the consumer and/or specified by different entities such as merchants, financial institutions, third-party advertisers, etc.

According to one embodiment, the system 100 can also include a payment processing system 165 communicatively coupled with the network 120 and a collections and reserve system 160 communicatively coupled with the payment processing system and/or the network 120. The payment processing system 165 and/or the collections and reserve system 160 may be operated, for example, by an acquirer participating in handling or processing financial transactions involving the client system 125, customer system 130, and/or the merchant system 135. One or more of the servers 105-115 can also be operated by the acquirer and can record information related to the transaction.

It should be noted that the presence and/or use of the collections and reserve system 160 can be considered to be optional. In some cases, functions performed by the collections and reserve system 160 may in performed by the payment processing system 165 or other system or may be omitted. If any event, details of the collections and reserve system and functions that can be performed thereby are described in detail in co-pending U.S. patent application Ser. No. 11/697,772 entitled “Collection and Reserve Systems and Methods” filed Apr. 9, 2007, which is hereby incorporated by reference in its entirety for all purposes.

As noted above, the payment processing system 165 can handle or process financial transactions involving the client system 125, customer system 130, and/or the merchant system 135. For example, the payment processing system 135 can receive information from the merchant system 135 related to one or more financial transactions such as credit card charges for sales. This information can be received periodically in a batch process such as when the merchant performs a “batch out” process at the close of a business day or other time. Such information can be provided to the acquirer to obtain payment by the financial institutions issuing the instruments used in the transactions.

According to one embodiment, prior to a collection of payment for the transactions, the payment processing system 165 can receive the information related to the transactions from the merchant system 135. Upon receiving the transaction information, the payment processing system can look up or read one or more rules from a rules repository 155. It should be noted that, while illustrated here as being separate from the payment processing system 165, the rules repository 155 can be maintained as part of the payment processing system 165 or another server 105-115 of the system 100. The rules, each comprising a logical combination of a condition and one or more corresponding actions, can define dispositions of the payment for the transactions to provide for collection of fees and/or chargebacks associated with the transaction. That is, the rules can define a relationship between the merchant and the acquirer and can be used to determine a level of risk to the acquirer in processing the transaction information. As such, the rules can define processes for handling the payment for those transactions in a manner to reduce the risk to the acquirer of not being able to collect fees and/or chargebacks related to the transactions.

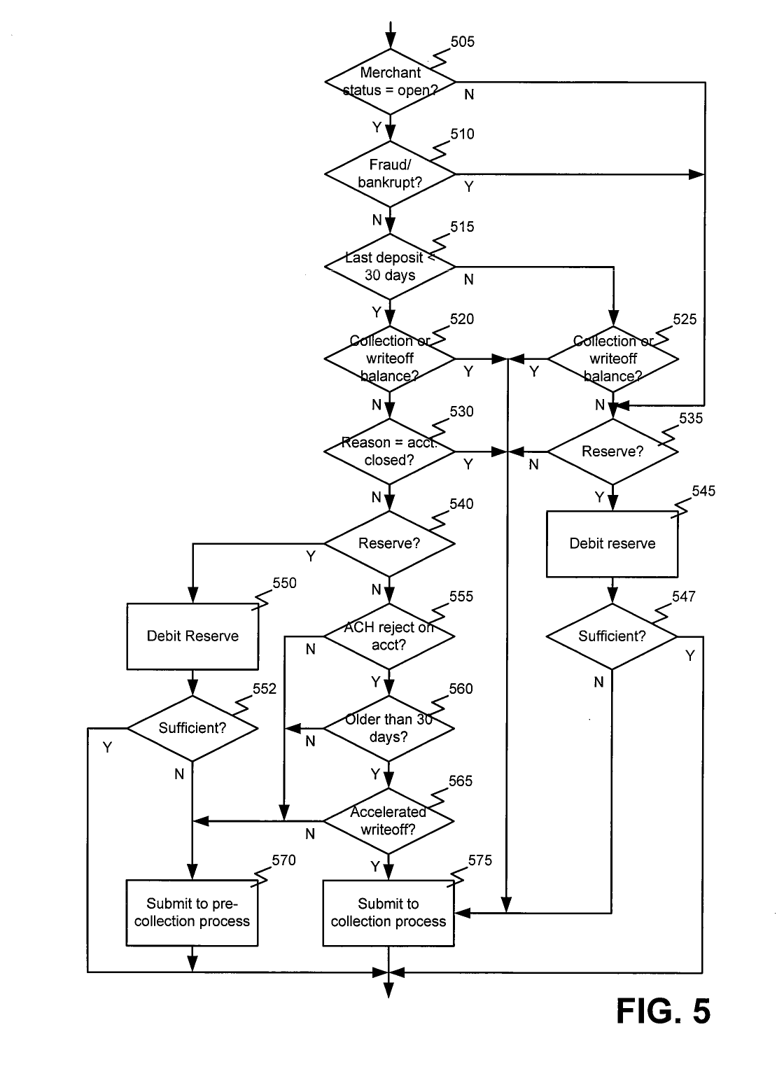

One or more rules can be selected from the rules repository 155 to be applied to the transaction information by the payment processing system 165. Selection of one or more rules can be based on a source of the information related to the transaction, i.e., the merchant system 135 providing the information, a type of the transaction, e.g., a credit card transaction, a check, etc., identity of one or more parties to the transaction, such as the merchant, the customer, etc., or other information related to the transaction. Additional details of exemplary rules and the application thereof are described below with reference to FIG. 5.

The one or more selected rules can be applied to the information related to the transactions by the payment processing system 165 and payment for the transactions can be handled based on applying the one or more rules. Handling payment for the transactions based on applying the one or more rules can comprise initiating a collections process or updating a previously initiated collections process. For example, the payment processing system 165 can provide the transaction information to the collections and reserve system 160 for processing as described in the application cited above.

In other instances, handling payment for the transactions based on applying the one or more rules can comprise initiating a pre-collections process. The pre-collections process can comprise, for example, requesting payment from the party to the transactions and/or debiting an account of the party to the transaction the amount of the fees. The pre-collections process may be implemented by the payment processing system 165, the collections and reserve system 160 in accordance with the processes described in the application cited above, or by another system maintained by the acquirer or another entity.

In other cases, handling the payment for the transactions based on applying the one or more rules can comprise performing a reserve process. The reserve process can comprise debiting a reserve account maintained for the party to the transaction the amount of the fees. According to one embodiment, the reserve account can be maintained by the collections and reserve system 160 in accordance with the embodiments described in the application cited above. In other embodiments, the reserve account may be maintained by the payment processing system of other system operated by the acquirer or other entity. Based on the agreement between the acquirer and the merchant, the rules may indicate fees and/or charges to be applied to and deducted from the reserve account for the transactions. The rules can also indicate whether some or all of these fees can be collected from the reserve account. In some cases, the reserve process can further comprises determining whether a balance of the reserve account falls below a minimum amount designated for the reserve account and, in response to determining the balance of the reserve account falls below the minimum amount designated for the reserve account, recovering an amount to replenish the reserve account and crediting the reserve account for the amount recovered. For example, the payment processing system 165 or other system maintaining the reserve account may request replenishment from a party such as a merchant associated with the reserve account or may collect the replenishment amount from the payment for the transaction.

In yet other cases, handling the payment for the transactions based on applying the one or more rules can comprise deducting the fees associated with the transaction from the payment for the transactions. That is, based on the agreement between the acquirer and the merchant, the rules may indicate fees and/or charges to be applied to and deducted from payments received for the transactions. The rules can also indicate whether some or all of these fees can be collected from the payment.

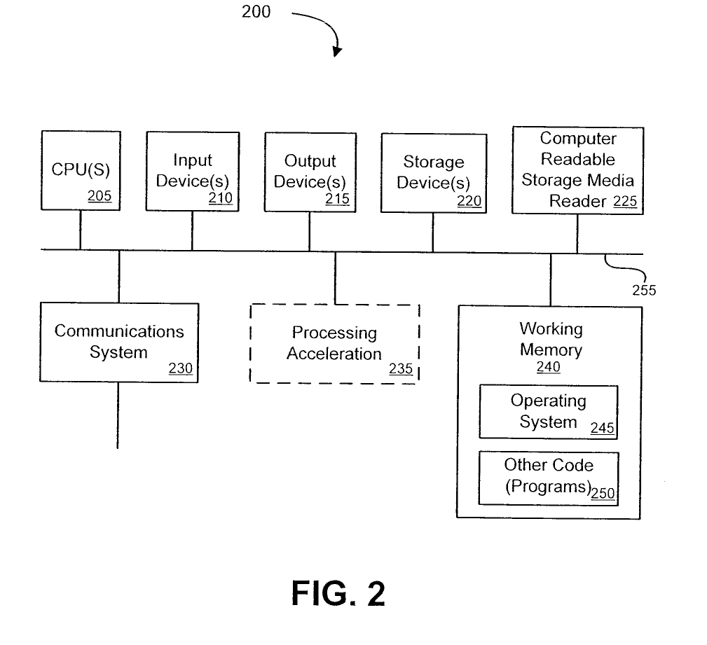

FIG. 2 is a block diagram illustrating an exemplary computer system upon which various elements of the exemplary environment illustrated in FIG. 1 may be implemented. The computer system 200 is shown comprising hardware elements that may be electrically coupled via a bus 255. The hardware elements may include one or more central processing units (CPUs) 205; one or more input devices 210 (e.g., a scan device, a mouse, a keyboard, etc.); and one or more output devices 215 (e.g., a display device, a printer, etc.). The computer system 200 may also include one or more storage device 220. By way of example, storage device(s) 220 may be disk drives, optical storage devices, solid-state storage device such as a random access memory (“RAM”) and/or a read-only memory (“ROM”), which can be programmable, flash-updateable and/or the like.

The computer system 200 may additionally include a computer-readable storage media reader 225; a communications system 230 (e.g., a modem, a network card (wireless or wired), an infra-red communication device, etc.); and working memory 240, which may include RAM and ROM devices as described above communicatively coupled with and readable by CPU(s) 205. In some embodiments, the computer system 200 may also include a processing acceleration unit 235, which can include a DSP, a special-purpose processor and/or the like.

The computer-readable storage media reader 225 can further be connected to a computer-readable storage medium, together (and, optionally, in combination with storage device(s) 220) comprehensively representing remote, local, fixed, and/or removable storage devices plus storage media for temporarily and/or more permanently containing computer-readable information. The communications system 230 may permit data to be exchanged with a network and/or any other computer or other type of device.

The computer system 200 may also comprise software elements, shown as being currently located within a working memory 240, including an operating system 245 and/or other code 250, such as an application program. The application programs may implement the methods of the invention as described herein. It should be appreciated that alternate embodiments of a computer system 200 may have numerous variations from that described above. For example, customized hardware might also be used and/or particular elements might be implemented in hardware, software (including portable software, such as applets), or both. Further, connection to other computing devices such as network input/output devices may be employed.

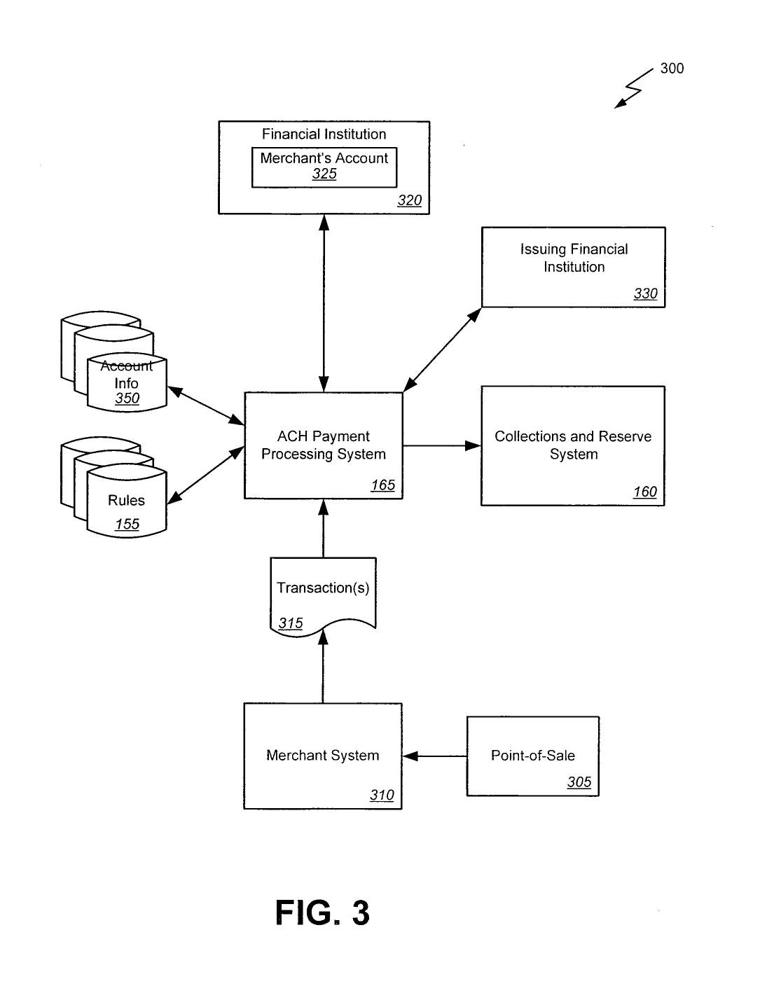

FIG. 3 is a block diagram illustrating functional components of a system for processing financial transactions according to one embodiment of the present invention. As noted above, the payment processing system 165 can be adapted to receive information 315 related to a transaction from a merchant system 310 or other source. This information 315 may be provided periodically or based on some other criteria. For example, the merchant system 310 may provide the transaction information 315 to the payment processing system 165 periodically in a batch process such as when the merchant performs a “batch out” process for one or more point of sale devices 305 at the close of a business day. Such information can be provided to the acquirer to obtain payment by the issuing financial institutions 330, i.e., the financial institution 330 issuing the instruments used in the transactions with the merchant. Based on the transaction information 315, the payment processing system 165 can obtain payment from accounts of one or more issuing financial institutions 330 identified in the transaction information 315 and apply or credit the merchant account 325 of another or the same financial institution 320. However, as will be described, the payment processing system 165 can, prior to payment to the merchant's account 325, apply one or more rules to the transaction information 315 to determine a process for handling the payment(s).

According to one embodiment, prior to a collection of payment for the transactions, the payment processing system 165 can receive the information related to the transactions from the merchant system 135. Upon receiving the transaction information 315, the payment processing system 165 may first validate the information received. For example, the payment processing system 165 can check to determine whether the transaction information 315 is related information stored in a account information repository 350. Information in the account information repository 350 can identify one or more parties or other entities known to the acquirer system such as merchants, consumers, issuing financial institutions or others.

Upon receiving and perhaps validating the transaction information, the payment processing system can look up or read one or more rules from a rules repository 155. It should be noted that, while illustrated here as being separate from the payment processing system 165, the rules repository 155 can be maintained as part of the payment processing system 165 or another server 105-115 of the system 100. The rules, each comprising a logical combination of a condition and one or more corresponding actions, can define dispositions of the payment for the transactions to provide for collection of fees and/or chargebacks associated with the transaction. That is, the rules can define a relationship between the merchant and the acquirer and can be used to determine a level of risk to the acquirer in processing the transaction information. As such, the rules can define processes for handling the payment for those transactions in a manner to reduce the risk to the acquirer of not being able to collect fees and/or chargebacks related to the transactions.

One or more rules can be selected from the rules repository 155 to be applied to the transaction information by the payment processing system 165. Selection of one or more rules can be based on a source of the information related to the transaction, i.e., the merchant system 310 providing the information, a type of the transaction, e.g., a credit card transaction, a check, etc., identity of one or more parties to the transaction, such as the merchant, the customer, etc., or other information related to the transaction. Additional details of exemplary rules and the application thereof are described below with reference to FIG. 5.

The one or more selected rules can be applied to the transaction information 315 by the payment processing system 165 and payment for the transactions, i.e., from the issuing financial institution 330 to the merchant's account 325, can be handled based on applying the one or more rules. Handling payment for the transactions based on applying the one or more rules can comprise initiating a collections process or updating a previously initiated collections process. For example, the payment processing system 165 can provide the transaction information to the collections and reserve system 160 for processing as described in the application cited above.

In other instances, handling payment for the transactions based on applying the one or more rules can comprise initiating a pre-collections process. The pre-collections process can comprise, for example, requesting payment from the party to the transactions and/or debiting an account of the party to the transaction the amount of the fees. The pre-collections process may be implemented by the payment processing system 165, the collections and reserve system 160 in accordance with the processes described in the application cited above, or by another system maintained by the acquirer or another entity.

In other cases, handling the payment for the transactions based on applying the one or more rules can comprise performing a reserve process. The reserve process can comprise debiting a reserve account maintained for the party to the transaction the amount of the fees. According to one embodiment, the reserve account can be maintained by the collections and reserve system 160 in accordance with the embodiments described in the application cited above. In other embodiments, the reserve account may be maintained by the payment processing system of other system operated by the acquirer or other entity. Based on the agreement between the acquirer and the merchant, the rules may indicate fees and/or charges to be applied to and deducted from the reserve account for the transactions. The rules can also indicate whether some or all of these fees can be collected from the reserve account. In some cases, the reserve process can further comprises determining whether a balance of the reserve account falls below a minimum amount designated for the reserve account and, in response to determining the balance of the reserve account falls below the minimum amount designated for the reserve account, recovering an amount to replenish the reserve account and crediting the reserve account for the amount recovered. For example, the payment processing system 165 or other system maintaining the reserve account may request replenishment from a party such as a merchant associated with the reserve account or may collect the replenishment amount from the payment for the transaction.

Alternatively or additionally, maintaining the reserve account can comprise determining whether interest is earned on the reserve account. The collections and reserve system 160 can determining whether interest is earned on the reserve account can be based on applying a rule of the one or more rules 155 related to the portfolio 145. In response to determining interest is earned on the reserve account, an amount of interest earned can be determined. Determining the amount of interest earned can be based, for example on an interest rate, schedule, flat fee, or other information from a table of information 150 related to the reserve account. The interest earned can be handled or applied based on a rule of the one or more rules. For example, handling the interest can comprise returning the interest to the party to the transaction, e.g., the merchant, or crediting the amount of interest to the sub-ledger 330 for the reserve account.

In yet other cases, handling the payment for the transactions based on applying the one or more rules can comprise deducting the fees associated with the transaction from the payment for the transactions. That is, based on the agreement between the acquirer and the merchant, the rules may indicate fees and/or charges to be applied to and deducted from payments received for the transactions. The rules can also indicate whether some or all of these fees can be collected from the payment.

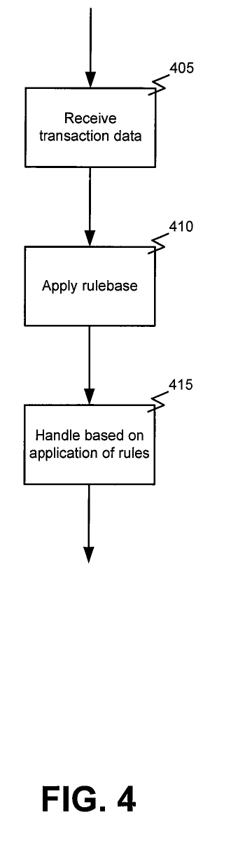

FIG. 4 is a flowchart illustrating a process for processing financial transactions according to one embodiment of the present invention. In this example, the process can, prior to a collection of payment for the transactions, receive 405 information related to a plurality of transactions from a party to the transactions such as, for example, a merchant. One or more rules can be applied 410 to the information related to the plurality of transactions. The one or more rules can define dispositions of the payment for the transactions to provide for collection of fees and/or chargebacks associated with the transactions. Payment for the transactions can be handled 415 based on applying the one or more rules.

Handling 415 payment for the transactions based on applying 410 the one or more rules can comprise initiating a collections process or updating a previously initiated collections process. In other instances, handling 415 payment for the transactions based on applying 410 the one or more rules can comprise initiating a pre-collections process. The pre-collections process can comprise, for example, requesting payment from the party to the transactions and/or debiting an account of the party to the transaction the amount of the fees. In other cases, handling 415 the payment for the transactions based on applying 410 the one or more rules can comprise performing a reserve process. The reserve process can comprise debiting a reserve account maintained for the party to the transaction the amount of the fees. In some cases, the reserve process can further comprises determining whether a balance of the reserve account falls below a minimum amount designated for the reserve account and, in response to determining the balance of the reserve account falls below the minimum amount designated for the reserve account, recovering an amount to replenish the reserve account and crediting the reserve account for the amount recovered. In yet other cases, handling 415 the payment for the transactions based on applying 410 the one or more rules can comprise deducting the fees associated with the transaction from the payment for the transactions.

It should be understood that the rules applied to the information related to the financial transaction can vary significantly between various implementations of the various embodiments of the present invention. For example, rules for handling payments for the financial transactions may include consideration of a status of the merchant, whether a past fraud or bankruptcy by the merchant has been identified or determined, a time since a last activity by the merchant, whether there is a collection and/or writeoff balance associated with the merchant, a reason for a rejected payment, if any, a time since the last rejection, if any, and other possible criteria. However, the rules may vary based on the preferences of the acquirer, the various financial institutions involved, agreements between the acquirer and the merchants and/or other parties, and any other criteria. Thus the following example illustrating application of a set of rules should not be considered limiting. Rather, this example is provided for illustrative purposes only.

FIG. 5 is a flowchart illustrating an exemplary process of applying a set of rules to information related to a financial transactions according to one embodiment of the present invention. This example assumes that a fee or charge will be incurred for a particular transaction such as for a returned or rejected transaction. In other cases, the transaction may not have a fee or chargeback applied. Such determination(s) may be made by additional rules not represented here.

In the example illustrated in FIG. 5, processing begins with determining 505 a status for the merchant. If the status of the merchant is determined 505 to be other than open, i.e., the merchant is not active and/or not permitted to seek payment through the system, a determination 535 can be made as to whether a reserve account is maintained for that merchant. For example, even if the merchant's status is not open, e.g., closed, the payment processing system may still maintain a reserve account for that merchant for sometime thereafter. If a determination 535 is made that a reserve account does exist for the merchant, the reserve account can be debited 545 for the amount of the fees and/or chargebacks. A determination 547 can then be made as to whether the reserve account is sufficient to cover the fees and/or chargebacks. If a determination 547 is made that the reserve account is not sufficient, information related to the transactions and/or the fees can be submitted 575 to a collections process.

If the status of the merchant is determined 505 to be open, i.e., the merchant is active and/or permitted to seek payment through the system, a determination 510 can be made as to whether a past fraud or bankruptcy by the merchant has been identified or determined. If 510 a past fraud or bankruptcy by the merchant has been identified, a determination 535 can be made as to whether a reserve account is maintained for that merchant. If a determination 535 is made that a reserve account does exist for the merchant, the reserve account can be debited 545 for the amount of the fees and/or chargebacks. A determination 547 can then be made as to whether the reserve account is sufficient to cover the fees and/or chargebacks. If a determination 547 is made that the reserve account is not sufficient, information related to the transactions and/or the fees can be submitted 575 to a collections process.

If 510 a past fraud or bankruptcy by the merchant has not been identified, a determination 515 can be made as to whether the last deposit or other activity by the merchant has been made within the past 30 days or other time period. If a determination 515 is made that the last deposit or other activity by the merchant has not been made within the past 30 days or other time period, a determination 525 can the made as to whether a collection or writeoff balance exists for that merchant. If 525 a collection or writeoff balance exists, information related to the transactions and/or the fees can be submitted 575 to a collections process. If 525 a collection or writeoff balance does not exist, a determination 535 can be made as to whether a reserve account is maintained for that merchant. If a determination 535 is made that a reserve account does exist for the merchant, the reserve account can be debited 545 for the amount of the fees and/or chargebacks. A determination 547 can then be made as to whether the reserve account is sufficient to cover the fees and/or chargebacks. If a determination 547 is made that the reserve account is not sufficient, information related to the transactions and/or the fees can be submitted 575 to a collections process.

If a determination 515 is made that the last deposit or other activity by the merchant has been made within the past 30 days or other time period, a determination 520 can the made as to whether a collection or writeoff balance exists for that merchant. If 520 a collection or writeoff balance exists, information related to the transactions and/or the fees can be submitted 575 to a collections process. If 520 a collection or writeoff balance does not exist, a determination 530 can be made as to whether a reason for a rejection or fee is a closed account. If 530 the reason for a rejection or fee is a closed account, information related to the transactions and/or the fees can be submitted 575 to a collections process.

If 530 the reason for a rejection or fee is not a closed account, a determination 540 can be made as to whether a reserve account is maintained for that merchant. If a determination 540 is made that a reserve account does exist for the merchant, the reserve account can be debited 550 for the amount of the fees and/or chargebacks. A determination 552 can then be made as to whether the reserve account is sufficient to cover the fees and/or chargebacks. If a determination 552 is made that the reserve account is not sufficient, information related to the transactions and/or the fees can be submitted 570 to a pre-collections process.

If a determination 540 is made that a reserve account does not exist for the merchant, a determination 555 can be made as to whether an ACH rejection exists on the account. If 555 an ACH rejection does not exist on the account, information related to the transactions and/or the fees can be submitted 570 to a pre-collections process.

If 55 an ACH rejection does exist on the account, a determination 560 can be made as to whether the rejection is older than some amount of time, e.g., 30 days. If a determination 560 is made that the rejection is not older than the amount of time, information related to the transactions and/or the fees can be submitted 570 to a pre-collections process.

If 560 a determination 560 is made that the rejection is older than the amount of time, a determination 565 can be made as to whether accelerated writeoff has been indicated for the account or merchant. If a determination 565 is made that early writeoff is not indicated, information related to the transactions and/or the fees can be submitted 570 to a pre-collections process. If a determination 565 is made that early writeoff is indicated, information related to the transactions and/or the fees can be submitted 575 to a collections process.

In the foregoing description, for the purposes of illustration, methods were described in a particular order. It should be appreciated that in alternate embodiments, the methods may be performed in a different order than that described. Additionally, the methods may contain additional or fewer steps than described above. It should also be appreciated that the methods described above may be performed by hardware components or may be embodied in sequences of machine-executable instructions, which may be used to cause a machine, such as a general-purpose or special-purpose processor or logic circuits programmed with the instructions, to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

While illustrative and presently preferred embodiments of the invention have been described in detail herein, it is to be understood that the inventive concepts may be otherwise variously embodied and employed, and that the appended claims are intended to be construed to include such variations, except as limited by the prior art.

What is claimed is:

1. A method of processing financial transactions prior to a collection of payment for the transactions, the method comprising:
receiving information related to a plurality of transactions from a party to the transactions;
applying one or more rules to the information related to the plurality of transactions, the one or more rules defining dispositions of the payment for the transactions to provide for collection of fees associated with the transactions; and
handling payment for the transactions based on applying the one or more rules.

2. The method of claim 1, wherein handling payment for the transactions based on applying the one or more rules comprises initiating a collections process.

3. The method of claim 1, wherein handling payment for the transactions based on applying the one or more rules comprises updating a previously initiated collections process.

4. The method of claim 1, wherein handling payment for the transactions based on applying the one or more rules comprises initiating a pre-collections process.

5. The method of claim 4, wherein the pre-collections process comprises requesting payment from the party to the transactions.

6. The method of claim 4, wherein the pre-collection process comprises debiting an account of the party to the transaction the amount of the fees.

7. The method of claim 1, wherein handling the payment for the transactions based on applying the one or more rules comprises performing a reserve process.

8. The method of claim 7, wherein the reserve process comprises debiting a reserve account maintained for the party to the transaction the amount of the fees.

9. The method of claim 8, wherein the reserve process further comprises:
determining whether a balance of the reserve account falls below a minimum amount designated for the reserve account; and
in response to determining the balance of the reserve account falls below the minimum amount designated for the reserve account, recovering an amount to replenish the reserve account and crediting the reserve account for the amount recovered.

10. The method of claim 1, wherein handling the payment for the transactions based on applying the one or more rules comprises deducting the fees associated with the transaction from the payment for the transactions.

11. The method of claim 1, wherein the party to the transactions comprises a merchant.

12. The method of claim 1, wherein the plurality of transactions comprise automated clearinghouse (ACH) transactions.

13. The method of claim 12, wherein the fees include chargebacks for rejected ACH transactions.

14. A system for processing an unfunded financial transaction, the system comprising:
a repository having stored therein a plurality of rule sets, wherein at least one rule set of the plurality of rule sets is associated with a party to the financial transaction;
a processor communicatively coupled with the repository; and
a memory communicatively coupled with and readable by the processor and having stored therein a series of instructions that, when executed by the processor, cause the processor to receive information related to a plurality of transactions from a party to the transactions, apply one or more rules to the information related to the plurality of transactions, the one or more rules defining dispositions of the payment for the transactions to provide for collection of fees associated with the transactions, and handle payment for the transactions based on applying the one or more rules.

15. The system of claim 14, wherein handling payment for the transactions based on applying the one or more rules comprises initiating a collections process.

16. The system of claim 14, wherein handling payment for the transactions based on applying the one or more rules comprises updating a previously initiated collections process.

17. The system of claim 14, wherein handling payment for the transactions based on applying the one or more rules comprises initiating a pre-collections process.

18. The system of claim 7, wherein the pre-collections process comprises requesting payment from the party to the transactions.

19. The system of claim 7, wherein the pre-collection process comprises debiting an account of the party to the transaction the amount of the fees.

20. The system of claim 14, wherein handling the payment for the transactions based on applying the one or more rules comprises performing a reserve process.

21. The system of claim 20, wherein the reserve process comprises debiting a reserve account maintained for the party to the transaction the amount of the fees.

22. The system of claim 21, wherein the reserve process further comprises:
determining whether a balance of the reserve account falls below a minimum amount designated for the reserve account; and
in response to determining the balance of the reserve account falls below the minimum amount designated for the reserve account, recovering an amount to replenish the reserve account and crediting the reserve account for the amount recovered.

23. The system of claim 14, wherein handling the payment for the transactions based on applying the one or more rules comprises deducting the fees associated with the transaction from the payment for the transactions.

24. The system of claim 14, wherein the party to the transactions comprises a merchant.

25. The system of claim 14, wherein the plurality of transactions comprise automated clearinghouse (ACH) transactions.

26. The system of claim 25, wherein the fees include chargebacks for rejected ACH transactions.

27. A machine-readable medium having stored thereon a series of instructions which, when executed by a processor, cause the processor to process financial transactions prior to a collection of payment for the transactions by:
receiving information related to a plurality of transactions from a party to the transactions;
applying one or more rules to the information related to the plurality of transactions, the one or more rules defining dispositions of the payment for the transactions to provide for collection of fees associated with the transactions; and
handling payment for the transactions based on applying the one or more rules.

28. The machine-readable medium of claim 27, wherein handling payment for the transactions based on applying the one or more rules comprises initiating a collections process.

29. The machine-readable medium of claim 27, wherein handling payment for the transactions based on applying the one or more rules comprises updating a previously initiated collections process.

30. The machine-readable medium of claim 27, wherein handling payment for the transactions based on applying the one or more rules comprises initiating a pre-collections process.

31. The machine-readable medium of claim 30, wherein the pre-collections process comprises requesting payment from the party to the transactions.

32. The machine-readable medium of claim 30, wherein the pre-collection process comprises debiting an account of the party to the transaction the amount of the fees.

33. The machine-readable medium of claim 27, wherein handling the payment for the transactions based on applying the one or more rules comprises performing a reserve process.

34. The machine-readable medium of claim 33, wherein the reserve process comprises debiting a reserve account maintained for the party to the transaction the amount of the fees.

35. The machine-readable medium of claim 34, wherein the reserve process further comprises:
determining whether a balance of the reserve account falls below a minimum amount designated for the reserve account; and
in response to determining the balance of the reserve account falls below the minimum amount designated for the reserve account, recovering an amount to replenish the reserve account and crediting the reserve account for the amount recovered.

36. The machine-readable medium of claim 27, wherein handling the payment for the transactions based on applying the one or more rules comprises deducting the fees associated with the transaction from the payment for the transactions.

37. The machine-readable medium of claim 27, wherein the party to the transactions comprises a merchant.

38. The machine-readable medium of claim 27, wherein the plurality of transactions comprise automated clearinghouse (ACH) transactions.

39. The machine-readable medium of claim 38, wherein the fees include chargebacks for rejected ACH transactions.
